(19) United States
(12) Patent Application Publication
(10) Pub. No.: US 2012/0087340 A1
(43) Pub. Date: Apr. 12, 2012

(54) Circuit Switch FallBack Reselection

(75) Inventors: Yong Yang, Molndal (SE); Ann-Christine Sander, Vastra Frolunda (SE); Gunnar Rydnell, Vastra Frolunda (SE)

(73) Assignee: Telefonaktiebolaget L M Ericsson (publ), Stockholm (SE)

(21) Appl. No.: 13/116,039

(22) Filed: May 26, 2011

Related U.S. Application Data
(60) Provisional application No. 61/391,215, filed on Oct. 8, 2010.

(30) Foreign Application Priority Data
Apr. 23, 2011 (EP) PCT/EP2011/058353

(51) Int. Cl. H04W 36/00

(52) U.S. Cl. 370/331

(57) ABSTRACT

There is provided methods for a user equipment (UE) and a user equipment being adapted to be attached and connected to a 2G/3G access network via a mobile switching centre (MSC) for performing at least circuit switched, CS, communication, or via a LTE access network and further on to a mobility management entity (MME) node, for performing packet switched, PS, and/or circuit switched, CS, communication. The user equipment (UE) is being adapted to receiving page signals (11, 12, 13) from the network side so as to inform the user equipment of incoming calls, the user equipment moreover being adapted to respond to page signals, such as by issuing page response signals (20). The user equipment (UE) is being adapted for responding with an Extended Service Request (15) message to the mobility management entity (MME) for triggering the mobility management entity (MME) to initiate handover to the 2G/3G access network. The user equipment—when receiving a page request (13; 61) stemming from a mobile switching centre (MSC), such as an IMSI page message (13) via a MME (12), and the IMSI page message contains a IMSI (62) and a CS domain indicator,—the user equipment being adapted for, without attempting to re-attach (63) to the mobility management entity (MME) over which the page was received, issuing a page response message (20; 68) to the mobile switching centre (MSC), thus performing cell reselection (67) to a 2G/3G access network for performing CS communication via the mobile switching centre (MSC).

### TECHNICAL FIELD

This invention relates to methods and means for affecting the choice of various access and attachment options in telecommunication networks. More specifically the present invention relates to fall back to circuit switched communication when being in a network having packet switched.

### BACKGROUND

In the 3GPP CSFB (Circuit Switched FallBack) architecture 3GPP TS 23.272 v10.1.0 a user equipment, UE, may be reached for terminating (i.e. making or establishing) a circuit switched, CS, call via paging in the, packet switched, PS, domain.

FIG. 1 shows a prior art non-roaming network architecture in which communication may be carried through various 3GPP access and network technologies. There is shown a GERAN (GSM EDGE Radio Access Network, ˜referred to as 2G) access interface (comprising a BSS (Base Station Subsystem (not shown)), a UTRAN (UMTS Terrestrial Access Network, ˜referred to as 3G,) interface (comprising a NodeB base station (not shown)) and a E-UTRAN (referred to as LTE (Long Term Evolution)) interface (comprising a eNodeB base station (not shown)).

On the core network side, the GERAN and the UTRAN access network both have interfaces to the SGSN (Serving GPRS Support Node) and the MSC (Mobile Switching Centre) server, the latter also being referred to as having VLR (Visitor Location Register) capabilities. PS services are routed via the SGSN, while CS services are routed through the MSC. The MME (Mobility Management Entity), on the other hand is the key control-node for the LTE access-network. It is responsible for idle mode UE (User Equipment) tracking and paging procedure including retransmissions. It is involved in the bearer activation/deactivation process and is also responsible for choosing the SGW (Signaling Gateway) for a UE at the initial attach and at time of intra-LTE handover involving Core Network (CN) node relocation.

Other known nodes shown in FIG. 1 are HSS (Home Subscriber Server), PCEF/PGW (Packet gateway) and PCRF (Policy Charging and Rules Function).

The UE registers in the MME using the Combined EPS/IMSI attach, and the MSC is updated for UE registration by the MME. The interface used between the MME and the MSC is the SGs interface. The function is used in case of no IMS voice support in the UE or in the network, whereby LTE is used for PS service while the fallback to CS is used for CS services, i.e. voice.

The following options noted in table 1 exist for a user equipment having 2G/3G access capabilities as well as LTE access capabilities in a cell where both LTE and 2G or 3G is available:

TABLE 1

| | | active/ | PS/CS/paging | |
|---|---|---|---|---|
| technology | attachment | standby | options | |
| LTE-MME | non-attached | | | |
| | attached | ECM- | PS; CS; | |
| | | CONNECTED | combined CS | |
| | | | and PS | |
| | attached | 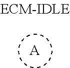 | no PS/no CS, page possible | |
| 2G/3G-CS-MSC | non-attached | | | |
| | attached | active | 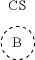 | |
| | attached | standby | | paging poss. |
| 2G/3G-PS-SGSN | non-attached | | | |
| | attached | active | PS | |

In table 1, the indications A and B does not correspond to the prior art.

According to TS 23.272, the UE may be in ECM-IDLE mode or in ECM-CONNECTED mode in LTE, while a terminating (MT—Mobile Terminated) or an originating (MO—Mobile Originated) CS call is initiated. (A user equipment, is also abbreviated MT in the literature; in the following the terms connected and idle will be used).

FIG. 1 shows a prior art figure from—3GPP TS 23.272 V10.1.0 (2010 September)—FIG. 4.2-1: EPS ARCHITECTURE FOR CS FALLBACK AND SMS OVER SGs. This figure shows the 3GPP architecture including the SGs interface for interconnecting the PS and CS domains.

FIG. 2, shows the initial steps of prior art figure—3GPP TS 23.272 V10.1.0 (2010 September)˜FIG. 7.2-1: MOBILE TERMINATING CALL IN IDLE MODE. This figure shows a paging method for MT (or UE) Call in idle mode It shows that the MSC receives a CS call, initiates a page over SGs via the MME since the UE is Combined attached. The UE receives the page in LTE and issues a Extended Service Request to the MME. The MME answers to MSC indicating that the UE has answered the page, and the MME also indicates to eNode B, that the UE is subject to CSFB.

The figure above includes the MT call, initiated paging from the MSC, to the MME, which pages the UE in the TA/TA List cells. After the UE answers the page, the procedure follows according to the TS 23.272 shown in FIG. 3.

FIG. 3, shows prior art figure—3GPP TS 23.272 V10.1.0 (2010 September)˜FIG. 7.3-1: CS PAGE IN UTRAN, CALL IN GERAN/UTRAN. This figure shows a Paging for MT Call in (for a UE being in) in ACTIVE mode. It shows that the MSC receives a CS call, initiates a page over SGs via the MME since the UE is Combined attached.

Since the UE is ACTIVE (i.e. ECM-Connected) there is no need to page the UE, but the MME can send a control message to the UE indicating CS MT call. The MME can immediately indicate to MSC that the paging is handled by sending the Service Request to the MSC. The UE receives the CS Paging Notification in LTE and issues a Extended Service Request to the MME. MME indicates to eNode B, that the UE is subject to CSFB.

The method described above for FIG. 2 involves paging via the MME when the UE is registered in the MME. For different reasons (elaborated below) the UE may be paged and answer to an MME, in which the UE is not registered and which therefore has no records of the UE. This may be a valid case and the CSFB procedure may continue and the CS call may be successfully setup. However, due to that the UE is not attached in the MME, the UE will prior to performing the CSFB be required to re-attach to the PS domain. Only after that, the UE will be redirected to CS domain for answering the page to the MSC and receiving the CS call. It is quite clear that the delay inflicted by the additional time it takes to make a re-attachment in the CS Domain before answering the call will be severe. The CSFB procedure under optimal conditions may take several seconds, and an additional delay—possibly in the order of seconds—may cause the calling party to hang up and the call to be lost. A delay optimization of the described procedure is needed.

### REFERENCES

3GPP TS 23.401 V10.1.0 General Packet Radio Service (GPRS) enhancements for Evolved Universal Terrestrial Radio Access Network.
3GPP TR 23.272 V10.1.0 Circuit Switched (CS) fallback in Evolved Packet System (EPS); Stage 2.
3GPP TS 29.118 V10.1.0 Mobility Management Entity (MME)—Visitor Location Register (VLR); SGs interface specification.
3GPP TS 24.301 V10.0.0 Non-Access-Stratum (NAS) protocol for Evolved Packet System (EPS); Stage 3.

The inventors of the present document have acknowledged the following problems:

### IMSI Paging

Normally, when the UE is IMSI attached, the MSC has allocated a TMSI (Temporary Mobile Subscriber Identity) to the UE, the MSC will page the UE via the MME and the TMSI will be used for paging the UE. The UE is attached in the MME that receives the page and the UE is paged by the MME in the TAs (Traffic Areas) registered using the TMSI. In some cases the IMSI paging will be used:
If the MME has restarted the MME may not have any record of the UE. The UE may be in IDLE mode and if the periodic update timer has not expired in the UE, the UE may not be aware that the MME is restarted. The MSC may also not be aware that the MME is restarted in case the optional RESET message is not sent from the MME to the MSC. In this case the MME can still page the UE if a page request is received from the MSC. The IMSI will be used in the page instead of the TMSI.
If the MME has crashed (or if the transmission between the MSC and the MME is lost) the SGs association between the MSC and the MME is lost. In some cases it may be possible for the MSC to page the UE via a different MME. This is particularly true in case of MME Pool, since the TA where the UE is located will be covered by multiple MMEs. The other MME used in this case, will not have any knowledge of the UE, but may still be able to page the UE.
Other cases may also be possible.

Common to these cases is that the UE believes itself to be attached to EPC and is still camping in LTE, thus is not reachable by paging in other RATs (Radio Acces Technologies).

### Paging the UE

The UE is paged according to FIG. 2, with a page message. The message may contain a suitable UE Identity (i.e. S TMSI or IMSI) and a CN Domain indicator. In this case the identity will be the IMSI. When the UE is paged, the UE would normally respond with the Extended Service Request. Since the UE is not registered in the MME it will respond with the Service reject message to the UE including the code (Implicitly detached) or optionally other appropriate code.

According to the TS 24.301 specification:
“#10 (Implicitly detached);
The UE shall delete the list of equivalent PLMNs and shall enter the state EMM-DEREGISTERED.NORMAL-SERVICE. The UE shall delete any mapped EPS security context or partial native EPS security context. The UE shall then perform a new attach procedure.”

I.e. the UE will then make a re-attach to the PS domain before being redirected to the CS domain.

### SUMMARY

It is first object to set forward a method for accomplishing a speedier reselection to 2G/3G circuit switched calls.

This object has been accomplished by a method for a user equipment being adapted to be attached and connected to a 2G/3G access network via a mobile switching centre for performing at least circuit switched, CS, communication, or via a LTE access network and further on to a mobility management entity node, for performing packet switched, PS, and/or circuit switched, CS, communication.

The user equipment is being adapted to receiving page signals from the network side so as to inform the user equipment of incoming calls, the user equipment moreover being adapted to respond to page signals, such as by issuing page response signals. The user equipment is moreover being adapted for responding with an Extended Service Request message to the mobility management entity for triggering the mobility management entity to initiate handover to the 2G/3G access network.

The method comprising the steps of—when receiving a page request stemming from a mobile switching centre, such as an IMSI page message via a MME, and the IMSI page message contains a IMSI and a CS domain indicator, the user equipment, without attempting to re-attach to the mobility management entity over which the page was received, issuing a page response message to the mobile switching centre, thus performing cell reselection to a 2G/3G access network for performing CS communication via the mobile switching centre.

Moreover, this object has been accomplished in an alternative way by a method for a user equipment being adapted to be attached and connected to a 2G/3G access network via a mobile switching centre for performing at least circuit switched, CS, communication, or via a LTE access network and further on to a mobility management entity node, for performing packet switched, PS, and/or circuit switched, CS, communication. The user equipment is being adapted to receiving page signals from the network side so as to inform the user equipment of incoming calls, the user equipment moreover being adapted to respond to page signals, such as by issuing page response signals. The user equipment is moreover being adapted for responding with an Extended Service Request message to the mobility management entity for triggering the mobility management entity to initiate handover to the 2G/3G access network. The method comprising the steps of when receiving a page request stemming from a mobile switching centre, such as an IMSI page message via a MME, and the IMSI page message contains a IMSI and a CS domain indicator, the user equipment issuing an Extended Service Request message to the MME, if the user equipment receives a Service Reject message from the MME, the user equipment, awaiting a service reject message from the MME, and when received, issuing a page response message to the mobile switching centre, thus performing cell reselection to a 2G/3G access network for performing CS communication via the mobile switching centre.

It is further object to set forward a user equipment for accomplishing a speedier reselection to 2G/3G circuit switched calls.

This object has been accomplished by a user equipment being adapted to be attached and connected to a 2G/3G access network via a mobile switching centre for performing at least circuit switched, CS, communication, or via a LTE access network and further on to a mobility management entity node, for performing packet switched, PS, and/or circuit switched, CS, communication.

The user equipment is being adapted to receiving page signals from the network side so as to inform the user equipment of incoming calls, the user equipment moreover being adapted to respond to page signals, such as by issuing page response signals. Moreover, the user equipment is being adapted for responding with an Extended Service Request message to the mobility management entity for triggering the mobility management entity to initiate handover to the 2G/3G access network.

The user equipment comprising a control unit effectuating the user equipment to—when receiving a page request stemming from a mobile switching centre, such as an IMSI page message via a MME, and the IMSI page message contains a IMSI and a CS domain indicator,
the user equipment being adapted for, without attempting to re-attach to the mobility management entity over which the page was received, issuing a page response message to the mobile switching centre, thus performing cell reselection to a 2G/3G access network for performing CS communication via the mobile switching centre.

Alternatively, this object has been accomplished by a user equipment being adapted to be attached and connected to a 2G/3G access network via a mobile switching centre for performing at least circuit switched, CS, communication, or via a LTE access network and further on to a mobility management entity node, for performing packet switched, PS, and/or circuit switched, CS, communication.

The user equipment is being adapted for receiving page signals from the network side so as to inform the user equipment of incoming calls, the user equipment moreover being adapted to respond to page signals, such as by issuing page response signals. Moreover, the user equipment is being adapted for responding with an Extended Service Request message to the mobility management entity for triggering the mobility management entity to initiate handover to the 2G/3G access network.

The user equipment comprises a control unit effectuating the user equipment to—when receiving a page request stemming from a mobile switching centre, such as an IMSI page message via a MME, and the IMSI page message contains a IMSI and a CS domain indicator, the user equipment issues an Extended Service Request message to the MME;
if the user equipment receives a Service Reject message from the MME, the user equipment being adapted for, awaiting a service reject message from the MME, and when received;
the user equipment a page response message to the mobile switching centre, thus performing cell reselection to a 2G/3G access network for performing CS communication via the mobile switching centre.

For all aspects above, the reselection to 2G/3G is accomplished at an enhanced speed.

Further advantages of the invention will appear from the following detailed description of the invention.

### BRIEF DESCRIPTION OF THE DRAWINGS

FIG. 1 shows a prior art network architecture,

FIG. 2 shows a prior art paging method for MT Call in IDLE mode,

FIG. 3 shows a prior art paging for MT Call in Active mode,

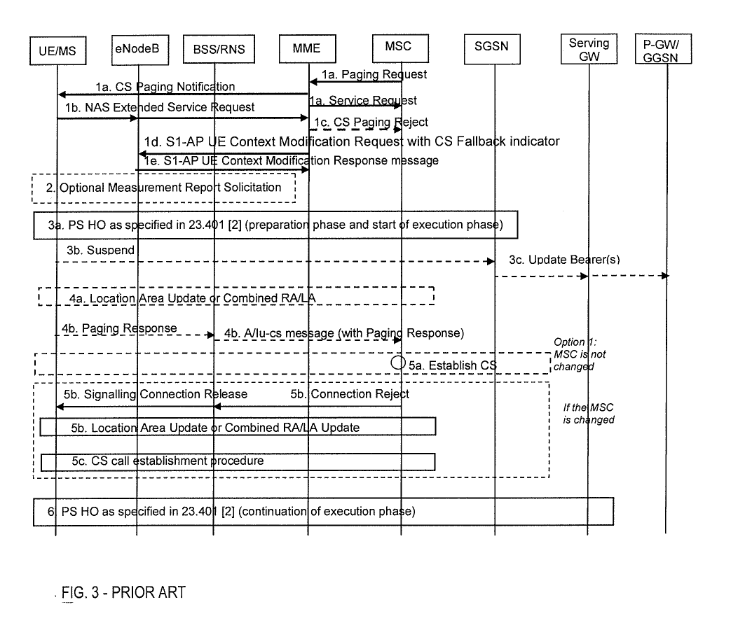

FIG. 4 shows a UE according to the invention,

FIG. 5 shows the UE behaviour of a first embodiment of the invention,

FIG. 6 shows a signalling diagram relating to the first embodiment of the invention,

FIG. 7 shows the UE behaviour of a second embodiment of the invention, and

FIG. 8 shows a signalling diagram relating to the second embodiment of the invention.

### DETAILED DESCRIPTION

This invention provides mechanisms providing a delay reduction for setting up a MT or MO call using CSFB in case the UE registration in the MME is lost or is missing. According to one aspect of the invention, when the MME receives a page from the MSC for a UE for which it has no record, the MME still has the possibility to page the UE by using the IMSI page method. The IMSI page may be performed in all of the service area of the MME or an optimized paging is possible in case the MSC provides location information in the paging request. When the UE answers to the page the MME will conclude that the UE is not registered and indicate to the UE to re-attach.

According to the invention, the UE will under certain conditions, skip the re-attachment and reselect immediately to the CS Domain to take the CS call. This will have the benefit that the CS call set-up time is decreased substantially, while the drawback would be that the PS services may be suffering in some cases. However, since the UE is, as explained below, probably is in IDLE mode, no PS session is taking place anyway in the cases discussed here. Furthermore, the cases addressed are error cases where the UE registration in the EPC is lost, the PS services are not currently possible to be utilized without re-attachment, and it is probably prioritized in this situation to answer a CS call before setting up a PS session.

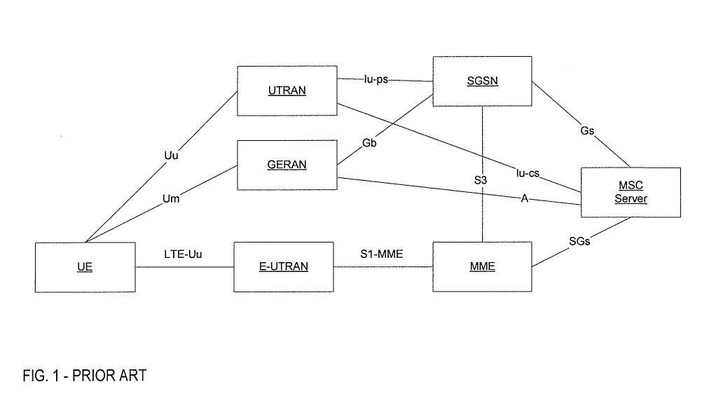

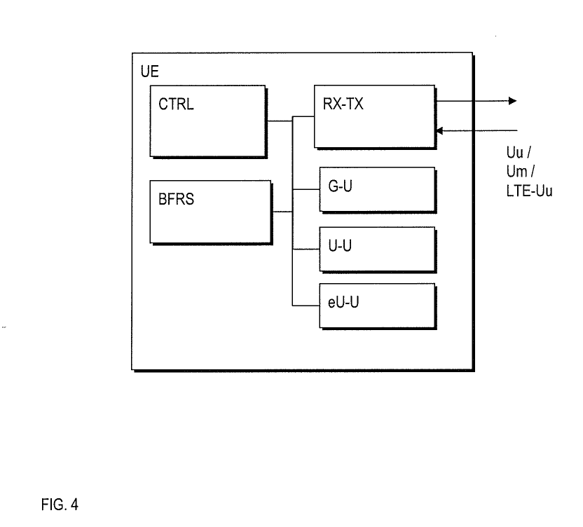

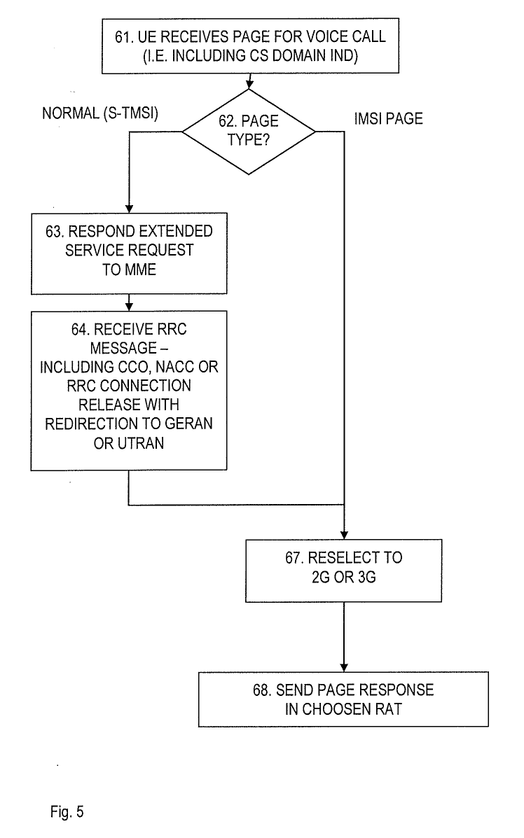

FIG. 4 shows a user equipment according to the invention comprising a control unit, CTRL, buffers, BFRS, for storing intermediately payload data for being transmitted from or received by the user equipment, and a receive transmit radio interface, RX-TX. Moreover, the user equipment comprises a unit G-U, dedicated to GERAN signalling over the known Um interface shown in FIG. 1, a unit U-U for UTRAN signalling over the known interface Uu, and a unit eU-U, for eUTRAN signalling over the known interface LTE-Uu, all signals being transmitted over the receive transmit radio interface RX-TX. The control unit, which may comprise a micro processor or an ASIC based device, is undertaking the role of effectuating the steps illustrated in FIGS. 5-8 according to the first and second embodiments of the invention, described in the following.

### First Embodiment of the Invention

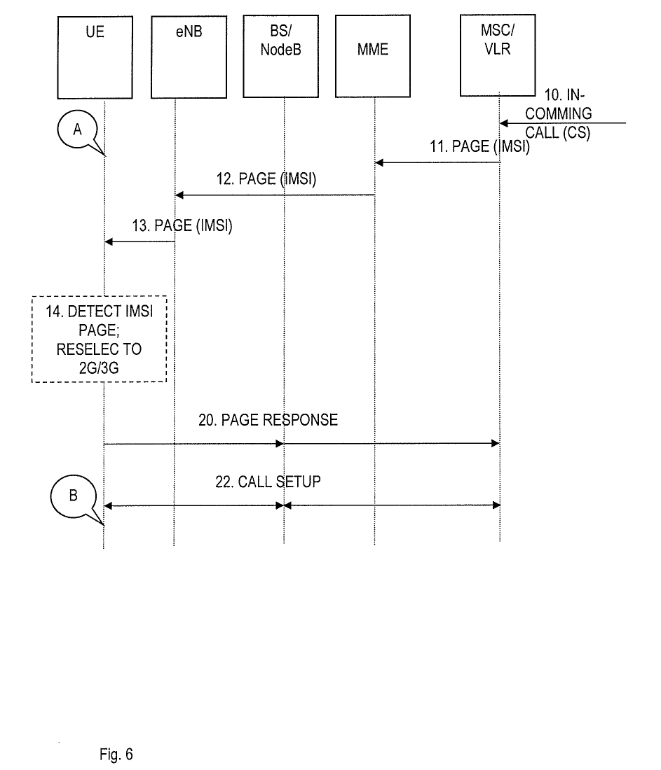

In FIG. 5, a flow diagram of the method steps carried out according to the first embodiment is shown. In FIG. 6 a corresponding signalling diagram for the first embodiment of the invention is shown, showing a possible scenario.

In step 61 the UE receives a page message for voice call including a CS domain indication. In Step 62, the page type of the message is determined as being of a normal S-TMSI page message or an IMSI page message.

If the former message is received, the method moves to step 63, where the UE responds by issuing a Extended service request to the MME. Following, this event upon receiving, step 64, a RRC message—including a CCO, NACC or RRC connection release with redirection to GERAN or UTRAN, the method continues to step 67, where the UE decides to reselect to the 2G or 3G radio interface, whereupon the UE sends a page response message in the chosen RAT.

However, if the answer in step 62 was that a IMSI page message was received, the method proceeds by directly to step 67.

As appears from FIG. 6, when an incoming CS call 10 is received in the MSC node (possibly having VLR capabilities), a page message with the given IMSI of the subscriber is transmitted further on to the MME, 11, which again transmits the page message, 12, further on to the eNodeB node, which again transmits the page message, 13, to the UE.

The UE is in this example attached to LTE in LTE idle mode, indicated by A in table 1.

Following the flow diagram step 62, the method proceeds directly to step 67 where a decision to reselect to 2G/3G is made—c.f. step 14 FIG. 6—the UE transmits a page response message 20 over the respective radio interface to the BS in 2G or NodeB in 3G. The latter node in question, forwards this massage to the MSC node. Subsequently the CS call is established by call setup messaging 22.

This effectuates that the UE is in this example attached to 2G/3G in active mode for CS calls, indicated by B in table 1.

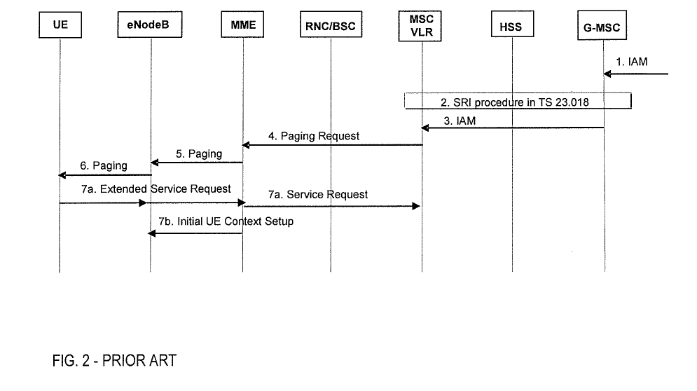

In contrast with the prior art procedure shown in FIG. 2, no extended service request message is replied with by the UE and the CS call can be terminated much speedier than in the prior art scenario.

It is noted that the option shown in the left hand side of FIG. 5, steps 63 and 64, corresponds to the known procedure when receiving a page message.

In other words there is provided a method for a user equipment being adapted to be attached and connected to a 2G/3G access network via a mobile switching centre for performing at least circuit switched, CS, communication, or via a LTE access network and further on to a mobility management entity node, for performing packet switched, PS, and/or circuit switched, CS, communication.

The user equipment is being adapted to receiving page signals from the network side so as to inform the user equipment of incoming calls, the user equipment moreover being adapted to respond to page signals, such as by issuing page response signals. The user equipment is moreover being adapted for responding with an Extended Service Request message to the mobility management entity for triggering the mobility management entity to initiate handover to the 2G/3G access network.

The method comprising the steps of—when receiving a page request stemming from a mobile switching centre, such as an IMSI page message via a MME, and the IMSI page message contains a IMSI and a CS domain indicator, the user equipment, without attempting to re-attach to the mobility management entity over which the page was received, issuing a page response message to the mobile switching centre, thus performing cell reselection to a 2G/3G access network for performing CS communication via the mobile switching centre.

There is also provided a user equipment (UE) being adapted to be attached and connected to a 2G/3G access network via a mobile switching centre (MSC) for performing at least circuit switched, CS, communication, or via a LTE access network and further on to a mobility management entity (MME) node, for performing packet switched, PS, and/or circuit switched, CS, communication.

The user equipment (UE) is being adapted to receiving page signals (11, 12, 13) from the network side so as to inform the user equipment of incoming calls, the user equipment moreover being adapted to respond to page signals, such as by issuing page response signals (20).

Moreover, the user equipment (UE) is being adapted for responding with an Extended Service Request (15) message to the mobility management entity (MME) for triggering the mobility management entity (MME) to initiate handover to the 2G/3G access network.

The user equipment comprises a control unit (CTRL) effectuating the user equipment to
when receiving a page request (13; 61) stemming from a mobile switching centre (MSC), such as an IMSI page message (13) via a MME (12), and the IMSI page message contains a IMSI (62) and a CS domain indicator,
the user equipment being adapted for, without attempting to re-attach (63) to the mobility management entity (MME) over which the page was received, issuing a page response message (20; 68) to the mobile switching centre (MSC), thus performing cell reselection (67) to a 2G/3G access network for performing CS communication via the mobile switching centre (MSC).

### Second Embodiment of the Invention

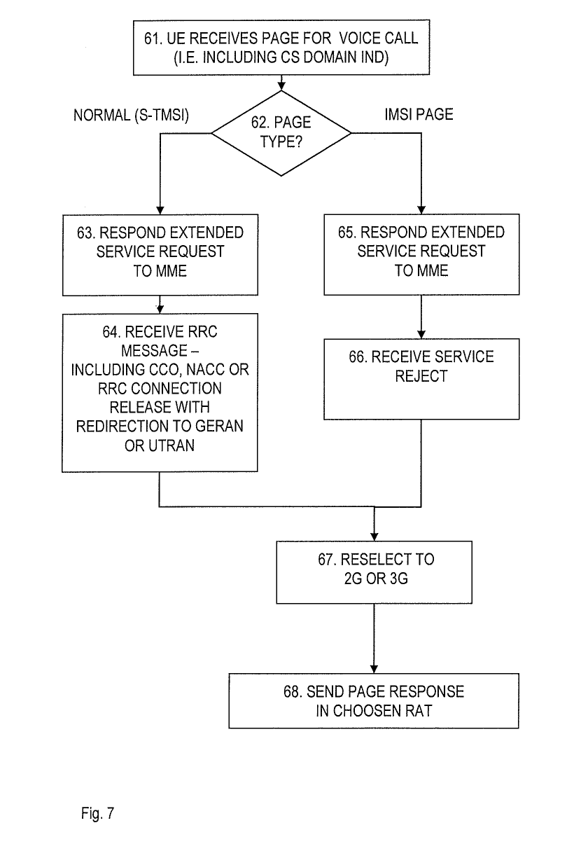

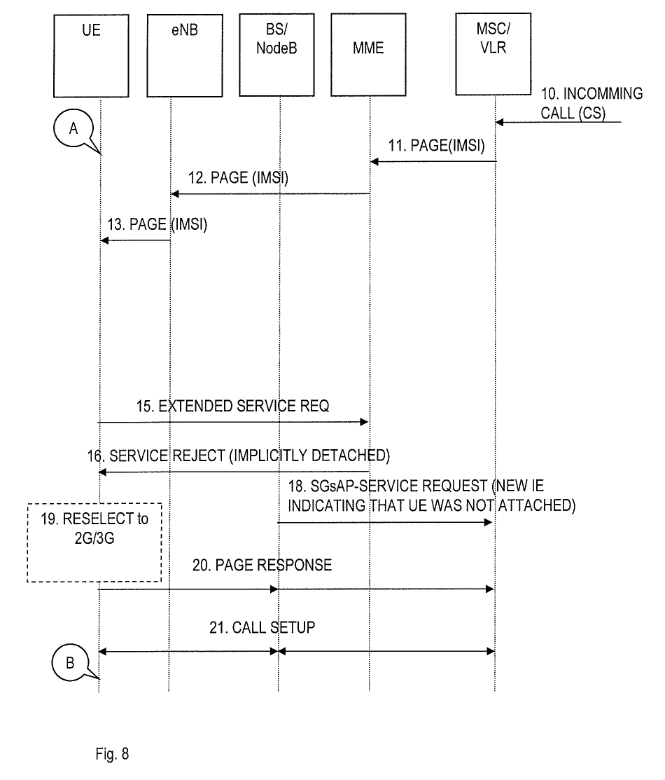

In FIGS. 7 and 8 a second embodiment of the invention is illustrated.

The second embodiment of the invention shown in FIG. 6 is similar to the first embodiment. However, two additional steps 65 and 66 are provided when branching from step 62 on the answer that an IMSI page was received. Otherwise, for the UE, the method steps having the same reference signs are as described with respect to FIG. 5.

In case the page message 13 includes the IMSI and the CS Domain Indicator, the UE concludes that it is paged for CSFB from a MME where it is not registered. In step 65, the UE respond with an extended service request 15 to the MME.

Hence, in this embodiment the UE do send the Extended Service Request back to the MME. The MME will respond to the UE with the Service reject message to the UE including the cause (Implicitly detached).

In step 66, the method proceeds when a service reject message 16 has been received.

When the UE receives the Service Reject, instead of re-attaching to EPC, the UE performs the IDLE mode cell reselection to the CS Domain, answers the page with a page response 20 and proceeds as in embodiment 1 above.

In addition the MME may send the SGsAP-SERVICE-REQUEST 18 is transmitted from the BS/NodeB to the MSC to inform the MSC to stop paging the UE. It comprises a new IE (Information Element) i.e. a parameter indicating that the UE was not attached. However, due to the exceptional condition that the UE is not attached in the MME, the SGsAP-SERVICE-REQUEST may not be populated with the correct IEs, e.g. IMEISV, the UE Time Zone, the Mobile Station Classmark 2, and the UE's current TAI (Tracking Area Indictor) and E-CGI (E-UTRAN Cell Global Identifier) may not be available. Instead a new IE indicating that the UE was not attached may be defined and included by the MME.

As appears from FIG. 8, the effect of the second embodiment is similar to the effect shown in FIG. 6, namely in step 19, a reselection to 2G or 3G is decided and a page response 20 being issued to the based station BS or NodeB, whatever applies in the cell.

In other words there is provided a method for a user equipment being adapted to be attached and connected to a 2G/3G access network via a mobile switching centre for performing at least circuit switched, CS, communication, or via a LTE access network and further on to a mobility management entity node, for performing packet switched, PS, and/or circuit switched, CS, communication.

The user equipment is being adapted to receiving page signals from the network side so as to inform the user equipment of incoming calls, the user equipment moreover being adapted to respond to page signals, such as by issuing page response signals. The user equipment is moreover being adapted for responding with an Extended Service Request message to the mobility management entity for triggering the mobility management entity to initiate handover to the 2G/3G access network. The method comprising the steps of when receiving a page request stemming from a mobile switching centre, such as an IMSI page message via a MME, and the IMSI page message contains a IMSI and a CS domain indicator, the user equipment issuing an Extended Service Request message to the MME, if the user equipment receives a Service Reject message from the MME, the user equipment, awaiting a service reject message from the MME, and when received, issuing a page response message to the mobile switching centre, thus performing cell reselection to a 2G/3G access network for performing CS communication via the mobile switching centre.

There is also provided a user equipment (UE) being adapted to be attached and connected to a 2G/3G access network via a mobile switching centre (MSC) for performing at least circuit switched, CS, communication, or via a LTE access network and further on to a mobility management entity (MME) node, for performing packet switched, PS, and/or circuit switched, CS, communication.

The user equipment (UE) is being adapted for receiving page signals (11, 12, 13) from the network side so as to inform the user equipment of incoming calls, the user equipment moreover being adapted to respond to page signals, such as by issuing page response signals (20). Moreover, the user equipment (UE) is being adapted for responding with an Extended Service Request (15) message to the mobility management entity (MME) for triggering the mobility management entity (MME) to initiate handover to the 2G/3G access network.

The user equipment comprises a control unit (CTRL) effectuating the user equipment to
when receiving a page request (13; 61) stemming from a mobile switching centre (MSC), such as an IMSI page message (13) via a MME, and the IMSI page message contains a IMSI (62) and a CS domain indicator, the user equipment (UE) issues an Extended Service Request message (65) to the MME;
if the user equipment receives a Service Reject (16; 66) message from the MME, the user equipment being adapted for, awaiting a service reject message from the MME (66), and when received;
the user equipment a page response message (20; 68) to the mobile switching centre (MSC), thus performing cell reselection (19; 67) to a 2G/3G access network for performing CS communication via the mobile switching centre (MSC).

This method affects the UE and the EPC.

### MO Calls

When a MO CS call is initiated by the UE in IDLE mode, a similar situation may happen if the MME has restarted. The UE can believe itself to be registered, while the MME has lost records of the UE. The UE may still be IMSI attached in the MSC if the MME has not sent RESET message to the MSC. When the UE sends the Extended Service Req to the MME indicating CSFB, the MME will respond with Service Reject (Cause #10) in the same manner as for MT Call. The UE is normally required to re-attach, to the EPC.

It is provided here that the UE instead also in this case immediately reselects to CS Domain and sends a CM Service Request to the CS Domain instead of re-attaching to PS Domain.

The present invention shortens the delay when the UE is paged for CSFB and the UE is not registered in the MME. This will yield a smaller risk for lost calls.

1. A method for a user equipment (UE) being adapted to be attached and connected to a 2G/3G access network via a mobile switching centre (MSC) for performing at least circuit switched, CS, communication,
or via a LTE access network and further on to a mobility management entity (MME) node, for performing packet switched, PS, and/or circuit switched, CS, communication,
the user equipment (UE) being adapted to receiving page signals (11, 12, 13) from the network side so as to inform the user equipment of incoming calls, the user equipment moreover being adapted to respond to page signals, such as by issuing page response signals (20),
the user equipment (UE) moreover being adapted for responding with an Extended Service Request (15) message to the mobility management entity (MME) for triggering the mobility management entity (MME) to initiate handover to the 2G/3G access network, the method comprising the steps of
when receiving a page request (13; 61) stemming from a mobile switching centre (MSC), such as an IMSI page message (13) via a MME (12), and the IMSI page message contains a IMSI (62) and a CS domain indicator,
the user equipment, without attempting to re-attach (63) to the mobility management entity (MME) over which the page was received, issuing a page response message (20; 68) to the mobile switching centre (MSC), thus performing cell reselection (67) to a 2G/3G access network for performing CS communication via the mobile switching centre (MSC).

2. Method according to claim 1, wherein if (62) a normal S-TMSI message is received,
the user equipment issuing an Extended Service Request message (63) to the mobility management entity (MME).

3. Method according to claim 2, awaiting a RRC message (64), and when received sending (68) a page response (20) message.

4. A method for a user equipment (UE) being adapted to be attached and connected to a 2G/3G access network via a mobile switching centre (MSC) for performing at least circuit switched, CS, communication,
or via a LTE access network and further on to a mobility management entity (MME) node, for performing packet switched, PS, and/or circuit switched, CS, communication,
the user equipment (UE) being adapted to receiving page signals (11, 12, 13) from the network side so as to inform the user equipment of incoming calls, the user equipment moreover being adapted to respond to page signals, such as by issuing page response signals (20),
the user equipment (UE) moreover being adapted for responding with an Extended Service Request (15) message to the mobility management entity (MME) for triggering the mobility management entity (MME) to initiate handover to the 2G/3G access network, the method comprising the steps of
when receiving a page request (13; 61) stemming from a mobile switching centre (MSC), such as an IMSI page message (13) via a MME, and the IMSI page message contains a IMSI and a CS domain indicator, the user equipment (UE) issuing an Extended Service Request message (65) to the MME,
if the user equipment receives a Service Reject (16; 66) message from the MME, the user equipment, awaiting a service reject message from the MME (66), and when received,
issuing a page response message (20; 68) to the mobile switching centre (MSC), thus performing cell reselection (19; 67) to a 2G/3G access network for performing CS communication via the mobile switching centre (MSC).

5. Method according to claim 4, wherein if (62) a normal S-TMSI message is received,
awaiting a RRC message (64), and when received
the user equipment issuing an Extended Service Request message (65) to the MME.

6. Method according to claim 5, when receiving a RRC message, subsequently sending (68) a page response (20) message.

7. A user equipment (UE) being adapted to be attached and connected to a 2G/3G access network via a mobile switching centre (MSC) for performing at least circuit switched, CS, communication,
or via a LTE access network and further on to a mobility management entity (MME) node, for performing packet switched, PS, and/or circuit switched, CS, communication,
the user equipment (UE) being adapted to receiving page signals (11, 12, 13) from the network side so as to inform the user equipment of incoming calls, the user equipment moreover being adapted to respond to page signals, such as by issuing page response signals (20),
the user equipment (UE) moreover being adapted for responding with an Extended Service Request (15) message to the mobility management entity (MME) for triggering the mobility management entity (MME) to initiate handover to the 2G/3G access network, the user equipment comprising a control unit (CTRL) effectuating the user equipment to—
when receiving a page request (13; 61) stemming from a mobile switching centre (MSC), such as an IMSI page message (13) via a MME (12), and the IMSI page message contains a IMSI (62) and a CS domain indicator,
the user equipment being adapted for, without attempting to re-attach (63) to the mobility management entity (MME) over which the page was received, issuing a page response message (20; 68) to the mobile switching centre (MSC), thus performing cell reselection (67) to a 2G/3G access network for performing CS communication via the mobile switching centre (MSC).

8. User equipment according to claim 7, wherein if (62) a normal S-TMSI message is received,
the user equipment issuing an Extended Service Request message (63) to the mobility management entity (MME).

9. Method according to claim 7, awaiting a RRC message (64), and when received, sending (68) a page response (20) message.

10. A user equipment (UE) being adapted to be attached and connected to a 2G/3G access network via a mobile switching centre (MSC) for performing at least circuit switched, CS, communication,
or via a LTE access network and further on to a mobility management entity (MME) node, for performing packet switched, PS, and/or circuit switched, CS, communication,
the user equipment (UE) being adapted to receiving page signals (11, 12, 13) from the network side so as to inform the user equipment of incoming calls, the user equipment moreover being adapted to respond to page signals, such as by issuing page response signals (20),
the user equipment (UE) moreover being adapted for responding with an Extended Service Request (15) message to the mobility management entity (MME) for triggering the mobility management entity (MME) to initiate handover to the 2G/3G access network, the user equipment comprising control unit (CTRL) effectuating the user equipment to—
when receiving a page request (13; 61) stemming from a mobile switching centre (MSC), such as an IMSI page message (13) via a MME, and the IMSI page message contains a IMSI (62) and a CS domain indicator, the user equipment (UE) issuing an Extended Service Request message (65) to the MME,
if the user equipment receives a Service Reject (16; 66) message from the MME, the user equipment being adapted for, awaiting a service reject message from the MME (66), and when received,
issuing a page response message (20; 68) to the mobile switching centre (MSC), thus performing cell reselection (19; 67) to a 2G/3G access network for performing CS communication via the mobile switching centre (MSC).

11. User equipment according to claim 10, wherein if (62) a normal S-TMSI message is received,
awaiting a RRC message (64), and when received
the user equipment being adapted for issuing an Extended Service Request message (65) to the MME.

12. User equipment according to claim 11, adapted for when receiving a RRC message, subsequently sending (68) a page response (20) message.
